(19) United States
(12) Patent Application Publication
(10) Pub. No.: US 2023/0164162 A1
(43) Pub. Date: May 25, 2023

(54) VALUABLE ALERT SCREENING METHOD EFFICIENTLY DETECTING MALICIOUS THREAT

(71) Applicant: HOSEO UNIVERSITY ACADEMIC COOPERATION FOUNDATION, Chungcheongnam-do (KR)

(72) Inventors: Tae Jin LEE, Gyeonggi-do (KR); Hong Bi KIM, Jeollanam-do (KR); Yong Soo LEE, Chungcheongnam-do (KR); Eun Gyu LEE, Gyeonggi-do (KR)

(21) Appl. No.: 17/988,939

(22) Filed: Nov. 17, 2022

(30) Foreign Application Priority Data
Nov. 23, 2021 (KR) 10-2021-0162305

(51) Int. Cl. H04L 9/40; G06N 20/20

(52) U.S. Cl. CPC H04L 63/1433; H04L 63/1416; G06N 20/20

(57) ABSTRACT

A valuable alert screening method for detecting malicious threat includes generating an AI model based on training data for predicting test data, generating XAI explainability and selecting important features based on summary plot by using an explainer and training data, performing range processing based on data distribution of important features selected for analysis without bias, calculating a SHAP value average and standard deviation of each range group and then storing them to determine suspicion and reliability of test data, making prediction by using an AI model generated in advance after feature processing in the same way as the training data at the time of inputting the test data, calculating a SHAP value by using the test data and the explainer, loading FOS calculation information to calculate FOS for each important feature, and calculating a suspicion score for each data by aggregating the FOS after calculating the FOS for each feature.

### CROSS-REFERENCE TO RELATED APPLICATION AND CLAIM OF PRIORITY

This application claims the benefit under 35 USC § 119 of Korean Patent Application No. 10-2021-0162305, filed on Nov. 23, 2021 in the Korean Intellectual Property Office, the disclosure of which is incorporated herein by reference in its entirety.

### BACKGROUND

### 1. Field of the Invention

The present invention relates to a technology for screening a valuable alert which a person has to analyze in a real security environment in which a large amount of attack alerts occur, and to a valuable alert screening method for efficiently detecting a malicious threat for an efficient cyber threat response technology through an explainable artificial intelligence (XAI) technology and a statistical analysis technique, to solve a problem of a real security environment that requires direct human intervention due to a false positive of an artificial intelligence (AI) model to respond to a cyber threat.

### 2. Description of the Related Art

Network bandwidth is increasing exponentially due to the development of the current IT infrastructure, and the number of users using it has also increased significantly. This leads to an increase in network traffic and an increase in security events, which is emerging as a major social problem. An intrusion detection system was introduced, but false detections and false positives are occurring, and there is a problem in that the security control efficiency is reduced due to the lack of control personnel to handle the alarms that occur in large numbers and the number of false positives in the alarms that occur.

In particular, as technology advances, the scope and damage scale of attacks that generate threats increase, and various attack methods appear. Accordingly, the amount of log data for tracking malicious behaviors is increasing. In fact, according to the Financial Security Service, it is reported that an average of 1 billion http requests occur per day.

In particular, as the number of remote and telecommuting increases and the cloud transition accelerates due to the global COVID-19 pandemic, security events of a different aspect than before are occurring in large numbers, and existing security personnel are unable to respond properly. According to SK infosec, the average monthly number of cyber attacks detected between January and March 2020 was 580,000, which is a 21% increase from the same period last year. Widespread cyber attack may disrupt infrastructure in a city or community and paralyze public systems and networks.

AI technology was introduced to analyze such a huge amount of malicious log data. However, the AI technology has problems with transparency, and the increased complexity makes it impossible to understand the reasons for the model's decision.

In addition, according to the Financial Security Service, SOC says that about 20 analysts analyze a large amount of malicious log data, and about 10,000 out of 200,000 attack alerts have been analyzed. In addition, due to the transparency problem of a model, it is necessary to analyze the entire log data, but there is a problem in that accurate analysis is difficult because the number of analysts is small compared to a large amount of malicious log data.

In order to solve the false positives of the AI model, it is necessary to interpret the AI model, and research to provide the interpretation of the AI model based on XAI is in progress. However, it is difficult to analyze a large amount of data in the real environment, as it can only check the degree of influence of each feature used to generate the AI model on the prediction.

### SUMMARY

Accordingly, an object of the present invention is to provide a valuable alert screening method for efficiently detecting malicious threat by generating a reliability indicator for AI prediction through XAI technology and statistical analysis technique to screen valuable alerts.

In order to achieve the object of the present invention, a valuable alert screening method for efficiently detecting malicious threat according to the present invention includes: a step 1 of generating an AI model based on training data for prediction of test data; a step 2 of generating XAI explainability and selecting important features based on summary plot by using an AI model explainer and training data; a step 3 of performing range processing based on data distribution of important features selected for analysis without bias; a step 4 of calculating a shapley additive explanations (SHAP) value average and standard deviation of each range group and then storing them to determine suspicion and reliability of test data; a step 5 of making prediction by using an AI model generated in advance after feature processing in the same way as the training data at the time of inputting the test data; a step 6 of calculating a SHAP value of the test data by using the test data and the explainer generated in advance; a step 7 of loading feature outlier score (FOS) calculation information to calculate FOS for each important feature of the test data; and a step 8 of calculating a suspicion score for each data by aggregating the FOS after calculating the FOS for each feature.

In the valuable alert screening method for efficiently detecting malicious threat according to the present invention, in the step 1, the AI model is generated after performing feature processing to process a training process of the AI model.

In the screening method according to the present invention, in the step 2, an explainer of the AI model is generated through libraries in Python, a SHAP value is calculated by using training data in the explainer, a summary plot is generated through the calculated SHAP value, top 20 important features are generated in the summary plot, and 10 important features analyzable on the basis of analyst's knowledge are selected out of the 20 features.

In the screening method according to the present invention, in the step 3, a range group is generated by adding the SHAP value to the range group when the number of data corresponding to a unique value for each important feature is counted and satisfies a setting condition.

In the screening method according to the present invention, the range is generated through the unique value of the feature.

In the screening method according to the present invention, a range, average, and standard deviation for each important feature are stored in the FOS calculation information.

In the screening method according to the present invention, in the step 7, each import feature value of each data of the test data is compared to the range stored in the FOS calculation information, and then FOS(abs(CDF−0.5)*2) is calculated by using information of the corresponding group and a SHAP value of test data.

In the screening method according to the present invention, a score representing a degree of abnormality for each important feature is calculated to determine reliability and suspicion of FOS (Feature Outlier Score) AI model prediction.

In the screening method according to the present invention, in the step 8, there is FOS for each important feature of each data, and when the FOS is above a setting threshold, the feature determines that the prediction of the AI model is suspicious, and when the FOS is below the threshold, the feature determines that the prediction of the AI model is reliable.

In the screening method according to the present invention, after the suspicion and reliability about the AI model prediction for each important feature are determined, a suspicion score is calculated by counting the number of suspicious features.

In the screening method according to the present invention, as the calculated suspicion score gets higher, the data is screened as data requiring more additional review.

### BRIEF DESCRIPTION OF THE DRAWINGS

FIG. 1 is a diagram for explaining local explanation;

FIG. 2 is a diagram illustrating SHAP extraction and important feature extraction;

FIG. 3 is a diagram for explaining range processing for each data distribution;

FIG. 4 is a diagram illustrating a progress of range processing for each data distribution;

FIG. 5 is a diagram illustrating an example of average and standard deviation for each feature range;

FIG. 6 is a diagram illustrating configuration of average and standard deviation for each feature range;

FIG. 7 is a diagram illustrating an NSL-KDD dataset;

FIG. 8A is a diagram illustrating normal and attack instances in an NSL-KDD dataset, and FIG. 8B and FIG. 8C are diagrams illustrating training data and test data;

FIG. 9 is a diagram for explaining feature selection;

FIG. 10 is a diagram illustrating XGBoost parameters;

FIG. 11 is a diagram illustrating an example of calculation of SHAP average and standard deviation for each range group;

FIG. 12A and FIG. 12B are diagrams illustrating examples of FOS-based suspicion rate calculation and analysis;

FIG. 13 is a diagram illustrating the number of data, the number of AI model error data among them, and an AI model error detection rate;

FIG. 14A and FIG. 14B are diagrams illustrating comparison of an error detection rate of an AI model for each data rate of a framework proposed in the present invention;

FIG. 15 is a diagram illustrating an error detection rate of an AI model; and

FIG. 16 is a diagram illustrating configuration for implementing a method according to the present invention.

### DETAILED DESCRIPTION

Hereinafter, preferred embodiments according to the present invention will be described in more detail with reference to the accompanying drawings.

Prior to the description of the present invention, the following specific structural or functional descriptions are only exemplified for the purpose of describing embodiments according to the concept of the present invention, and embodiments according to the concept of the present invention may be implemented in various forms and should not be construed as being limited to the embodiments described herein.

In addition, since the embodiment according to the concept of the present invention may have various changes and may have various forms, specific embodiments will be illustrated in the drawings and described in detail herein. However, this is not intended to limit the embodiments according to the concept of the present invention to a specific disclosed form and should be understood to include all modifications, equivalents and substitutes included in the spirit and scope of the present invention.

First, prior to the description of the present invention, the technology and terms related to the present invention will be defined as follows.

First, the present invention used a SHAP-based framework to solve a disadvantage of the existing IDS in which the reason for decision of a model cannot be unknown due to complexity and to provide better explanation. A framework that provides local and global explanations to all IDSs was proposed, and the SHAP method was applied for the first time to increase the transparency of IDSs. In addition to providing the explanation, the difference in interpretation between a one-vs-all classifier and a multiclass classifier was analyzed.

For the experiment, an NSL-KDD dataset was used, which includes a total of 42 features and was processed into 122 features through an encoding process. Local and global analysis was performed for each attack type, and comparison between the one-vs-classifier and the multiclass classifier was also performed.

As a result of the experiment, it was found that the SHAP contributed to the understanding of the reason for the determination made by a security officer and that it was possible to optimize a structure of the IDS or provide insight for better design through comparison between the classifiers. Through each graph, it was possible to intuitively interpret desired information.

Local: It is possible to check the main features that have become the determination index for each data and check validity.

Global: A model can check which level has high relevance by checking features considered important and comparing degrees of influences according to the level for each feature.

XAI (eXplainable Artificial Intelligence): Explainable AI that helps a user understand the overall strengths and weaknesses of an AI system.

Game theory: Theorization about what decisions or actions each other make in a situation where multiple topics influence each other.

Shapley values: A concept derived from cooperative game theory. The average value of all marginal contributions for all possible collaborations is the Shapley value. In a game where each feature predicted value of an instance is payment, there is presented a method of fairly distributing payment (=prediction) by quantifying the influence according to player's cooperation and non-cooperation. The Shapley value is applicable to both of classification (when dealing with probability) and regression models. It is a value obtained by subtracting the average predicted value of all instances from the actual prediction, and the computation time increases exponentially according to the number of features.

SHAP (Shapley Additive Explanations):

SHAP connects LIME and a Shapley value. Each SHAP value measures a degree to which each feature of a model contributes negatively or positively. There are two essential advantages of the SHAP. In other words, it means that the SHAP value can be calculated for all models that are not simple linear models, and that each record has its own SHAP value set.

The biggest difference from the LIME is an instance weight of the regression model. The LIME weights an instance according to how close it is to the original instance. Accordingly, the more 1 in a coalition vector, the greater the weight of the LIME.

However, the SHAP weights sample instances according to the weight that a coalition can obtain from Shapley value estimation. Accordingly, small coalitions (few 1) and large coalitions (many 1) receive the greatest weight.

The object of the SHAP is to provide a plot for predicted value explanation by calculating contribution of each feature for prediction.

Xboost:

This is an ensemble algorithm that uses a combination of several decision trees. An algorithm implemented using boosting is representative of Gradient Boost, and a library that implements this algorithm to support parallel learning is XGBoost. Although it is based on GBM, it solves the disadvantages of GBM such as slow execution time and overfitting regulation. Classification accuracy is excellent, but it is vulnerable to outliers.

According to the present invention, a valuable alert screening method for efficiently detecting malicious threat mainly includes three parts.

The first part is AI model generation. This generates an AI model by using training data. Feature preprocessing is performed by using the training data. Then, after XGboost learning by using refined features, a model is generated.

The second part is Global explanation provided. This processes a range and SHAP for FOS calculation. The SHAP is calculated by using the training data and the AI learning model, and important features are selected on the basis of the calculated SHAP and SHAP plot. A range work is performed on each selected important feature by using a feature value. An average and standard deviation are calculated by using Shapely values of data for each range, and a range, average, and standard deviation of the train data are stored for Local explanation.

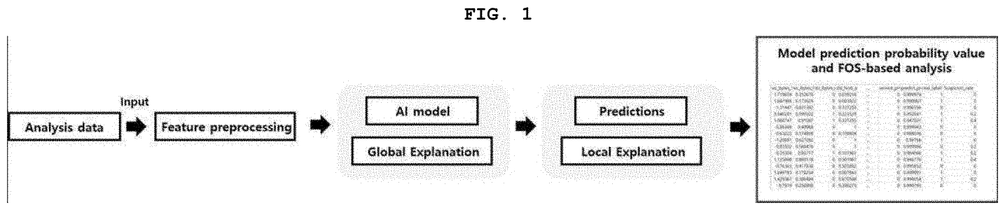

The third part is Local explanation provided (FIG. 1).

This is analysis of analysis data. Feature processing is performed by using the analysis data, and a prediction result is extracted by inputting the refined features to the AI model generated in advance. Then, the SHAP is calculated by using the analysis data and the AI learning model. The FOS calculation information generated in the second part is called, and the FOS is calculated according to the range suitable for each analysis data. A suspicion rate is measured by counting a case where the FOS of each feature is above a threshold, and an error of the AI model is detected through the FOS-based result analysis.

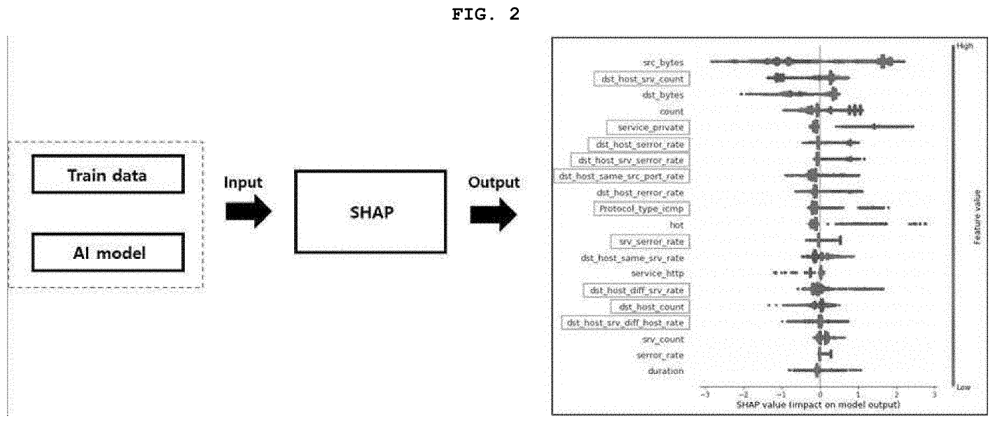

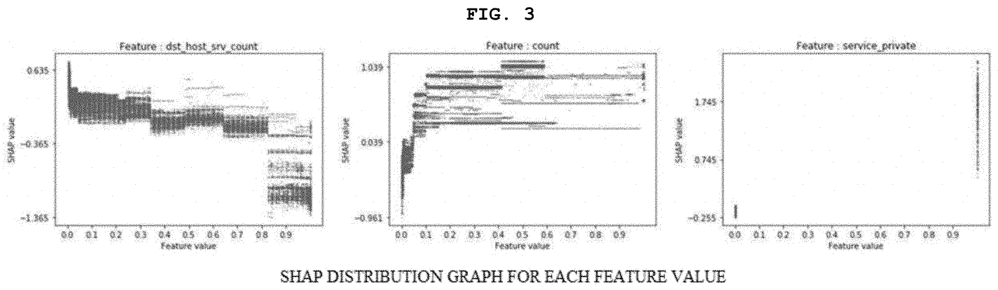

In the SHAP extraction and the important feature extraction as illustrated in FIG. 2 in the framework proposed in the present invention, the SHAP is extracted by using the AI learning model generated by using the training data, a plot about top 20 features having a major influence on the model learning is calculated after the SHAP extraction, and 10 features having a distinct SHAP value for each feature value are selected out of the top 20 features. Looking at the range processing for each data distribution, as illustrated in FIG. 3, the range processing is performed according to the data distribution for each feature value, and the range processing is performed by counting the number of data corresponding to each feature value. In order to minimize the case where the standard deviation of the range increases, if the number of data is above a threshold, it is processed as one range.

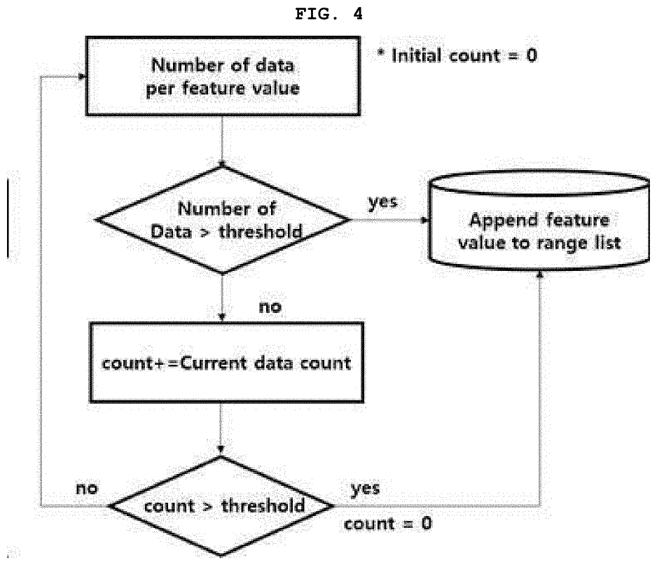

Referring to FIG. 4, the process of range processing for each data distribution is as follows.

case: feature value=[0.00˜1.00->increments by 0.01]

1. When the number of data of feature value=0.00 is above a threshold, it is selected as one range.

2. When the number of data of feature=0.01 is not above the threshold, the number of data of the next feature value (0.02) is summed.

3. The second step is repeated until the number of data is above the threshold, and then a range is selected.

Calculation of SHAP average and standard deviation for each range are as follows.

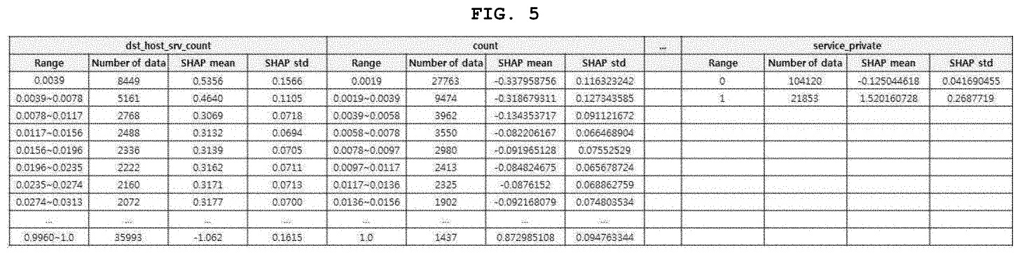

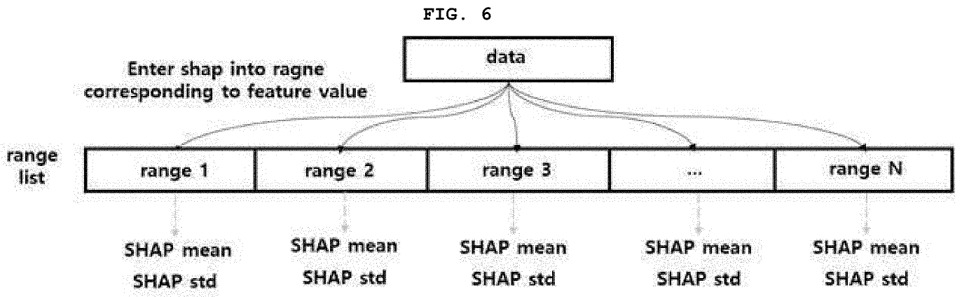

In order to generate a group for the data corresponding to each processed range, the feature value of each data and the range are compared. The group is generated by using the SHAP value of the data having the feature value corresponding to the range. Then, the SHAP average and standard deviation are calculated by using each generated range group. An example is illustrated in FIG. 5 in this regard.

Referring to FIG. 6, the process will be described in more detail as follows.

1. The first range stored in the range list is called and compared with the feature value of the analysis data.

2. When the feature value coincides with the range, the SHAP value of the data corresponding to the feature value is added to the group.

3. The average and standard deviation are calculated by using the SHAP value of the generated group.

4. After each of the average and standard deviation calculated for the local explanation is stored in the list, the next range is called and the processes 1 to 3 are performed.

5. The processes 1 to 4 are repeated until the comparison for the whole of the range list is completed.

The FOS (Feature Outlier Score) is as follows. The FOS is a score representing an anomaly degree with reference to the Shapley value according to the feature value for each attack type in data. Whether to suspect or trust the determination made by the AI model is determined through the FOS. When the FOS is high, the determination is suspected, and when the FOS is low, the determination is trusted.

The FOS calculation process is as follows.

1. Load storage information of average standard deviation calculated for each range and processed range for each data distribution (Load global explanation).

2. CDF is calculated by using the SHAP value, the average and standard deviation of the range group to which the feature value of each data corresponds.

3. The FOS is calculated by using the CDF (Formula: abs(CDF−0.5)*2). The further away from the average of the corresponding range group and the higher the standard deviation, the higher the FOS.

The FOS-based suspicion rate for analysis is calculated as follows.

When the FOS value for each feature is above a threshold, the determination is suspected, and when the FOS value is below the threshold, the determination is trusted. The suspicion score is calculated by counting the number of suspicious determination for each feature of each data.

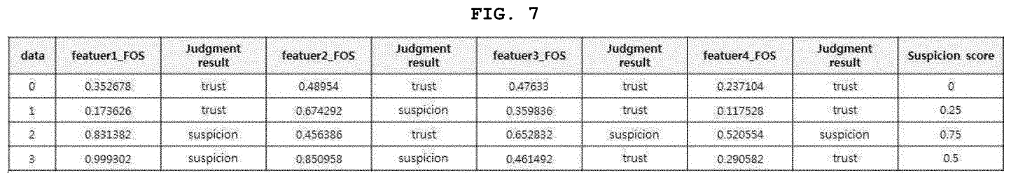

The example shown in FIG. 7 is as follows. The threshold is 0.5.

In the case of data 0, since there is no feature suspected of determination among all four features, the suspicion score is 0.

In the case of data 1, since there is one feature suspected of determination among all four features, the suspicion score is 0.25.

In the case of data 2, since there are three features suspected of determination among all four features, the suspicion score is 0.75.

In the case of data 3, since there are two features suspected of determination among all four features, the suspicion score is 0.5.

Hereinafter, the experiment of the present invention will be described as follows.

A dataset used for experiment in the present invention is an NSL-KDD dataset. This is a refined version that supplements the shortcomings of KDD'99, which was widely used in IDS construction. Since duplicate records are removed, it is not biased by the method having a better detection rate in frequent records. In addition, it is an effective dataset to help with comparison of various intrusion detection methods.

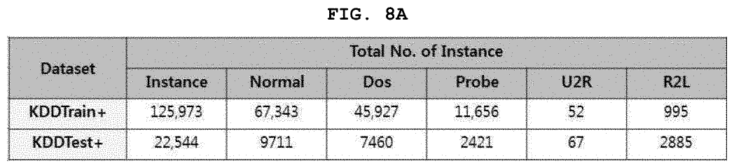

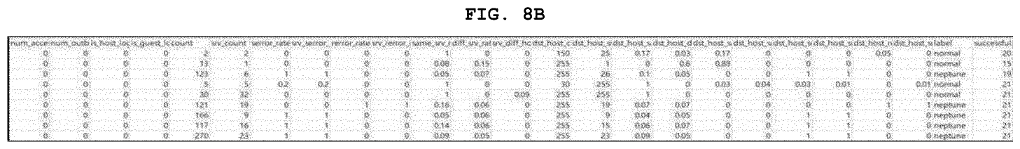

FIG. 8A to FIG. 8C illustrates the NSL-KDD dataset.

FIG. 8A illustrates an example of normal and attack instances in the NSL-KDD dataset, and FIG. 8B and FIG. 8C illustrate training data and test data.

In the present invention, features used in the feature processing are as follows.

Binary Features: Land, logged_in, root_shell, su_attempted, Is_hot_login, Is_guest_login

Continuous Features: duration, src_bytes, dst_bytes, etc.

Min-Max normalization

Symbolic Features: Protocol type, Service, Flag

One-Hot Encoding

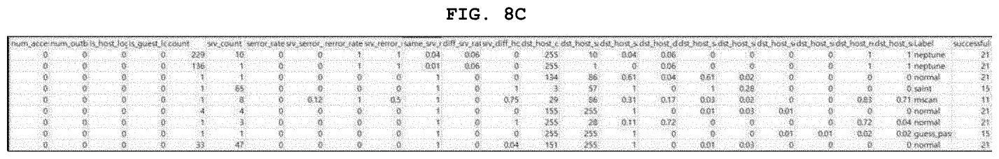

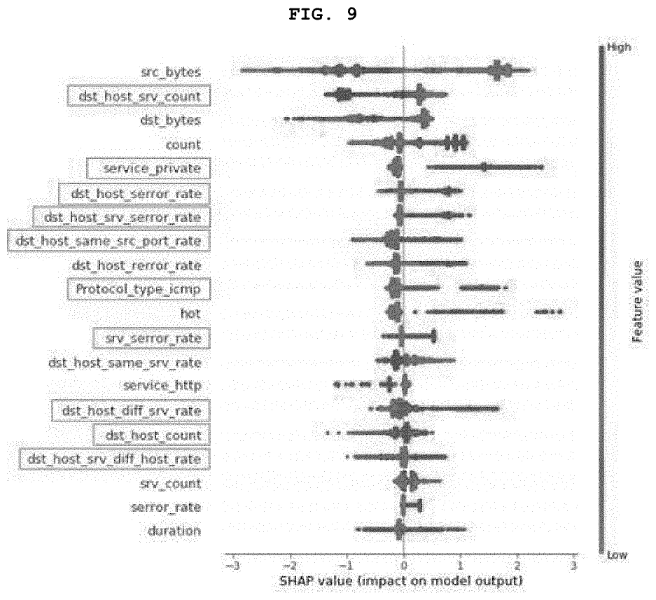

As illustrated in FIG. 9, Protocol type is converted into 3 types, Service is converted into 70 types, and Flag is converted into 11 types.

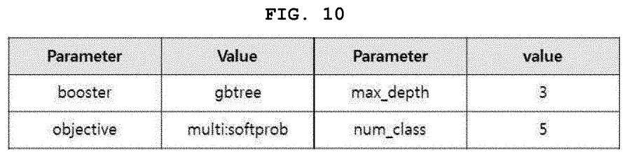

In the selection of the features, top 20 features having a major influence on model learning was checked through visualization of a summary plot after the extraction of SHAP, and 10 features having a distinct SHAP value for each feature value are selected out of the top 20 features for accurate analysis (see FIG. 10).

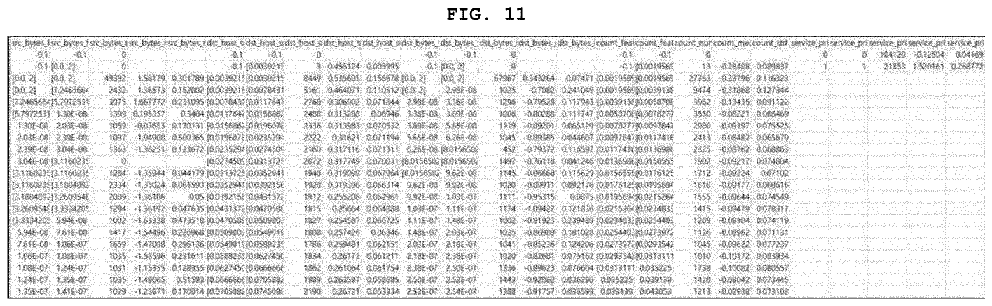

The AI model used an XGBoost algorithm for learning and analysis of the NSL-KDD dataset and used softprob, which is multiclass, for the extraction of the SHAP value, and the used XGBoost parameters are as illustrated in FIG. 11.

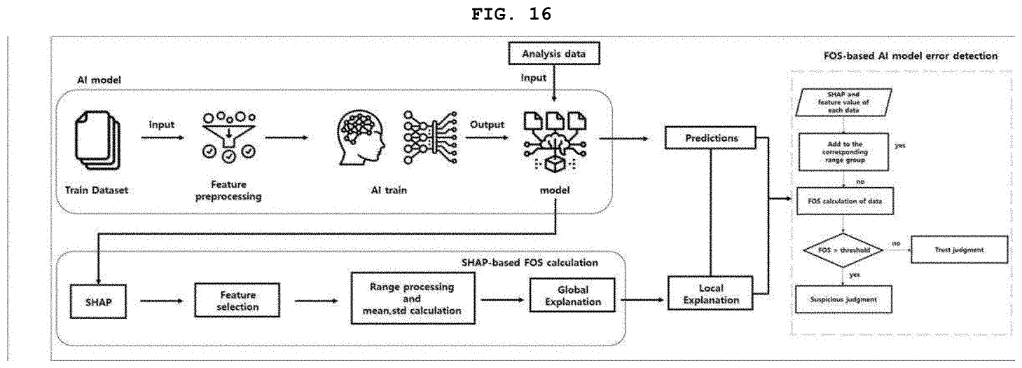

In the range processing and the calculation of the SHAP average and the standard deviation, the processing was performed as the range for each data distribution based on each feature value of the training data in accordance with a range processing logic. In this case, threshold=1,000 was set for the range processing. The SHAP average and the standard deviation for each range group were calculated in accordance with an average and standard deviation logic by using the processed range. An example is illustrated in FIG. 16.

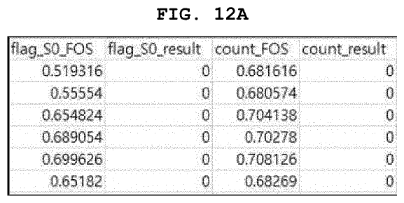

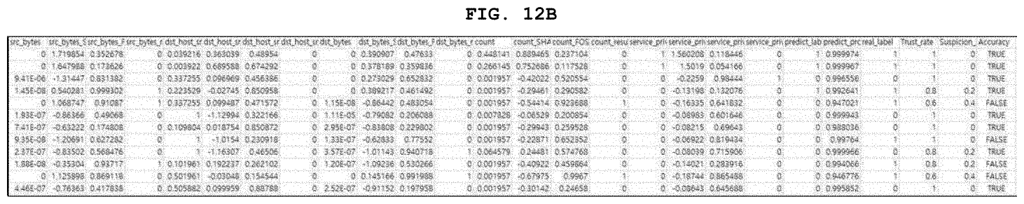

In the calculation and analysis of the FOS-based suspicion rate, FOS threshold=0.9 for analysis was set. When the FOS value for each feature is above 0.9, 1 (suspicious determination) was represented, and when the FOS value is below 0.9, 0 (reliable determination) was represented. An example of the result is illustrated in FIG. 12A.

The number of features represented as suspicious determination for each data was counted to calculate suspicion score, and the analysis was performed by using the calculated suspicion score and the prediction probability. An example of the analysis is illustrated in FIG. 12B.

In the result of the AI model, 4,480 of total 22,544 of the XGBoost prediction result were false positive, and a false positive rate was 19.87%.

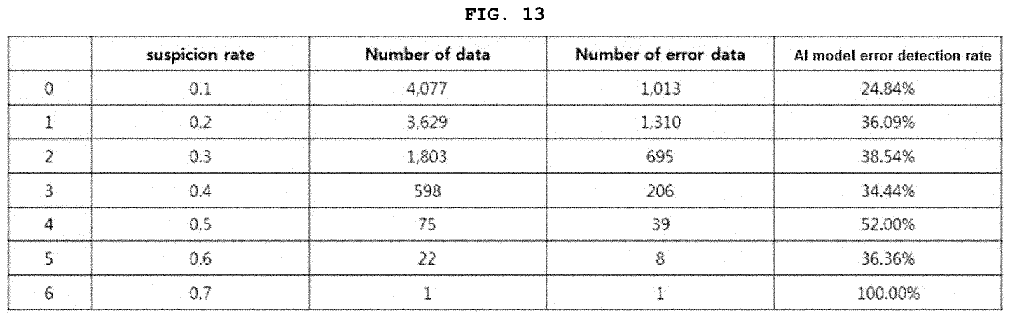

In the result of the FOS analysis, the number of cases where the total number of XAI determination suspicion (suspicion score) is above 0.1 was 10,208, the number of AI model errors of the XAI determination suspicion is 3,272 (AI model error detection rate: 32.05%). In cases with each suspicion score or higher, the number of data, the number of AI model error data, and the AI model error detection rate are as illustrated in FIG. 13.

When the threshold of the suspicion rate was set to 0.5, it can be seen that it is possible to find false determination of the AI with the highest probability of the error detection rate 52.00% of the AI model.

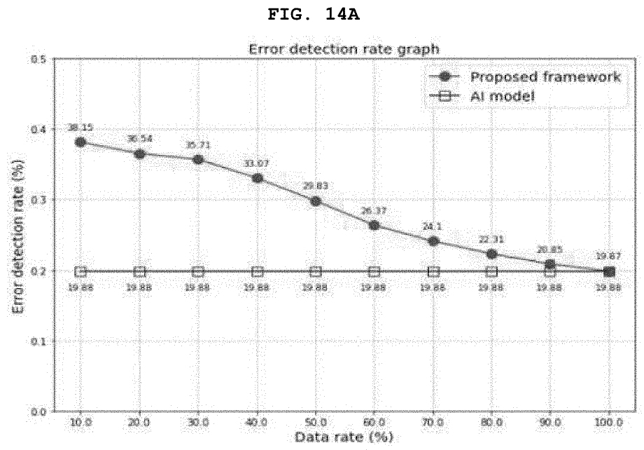

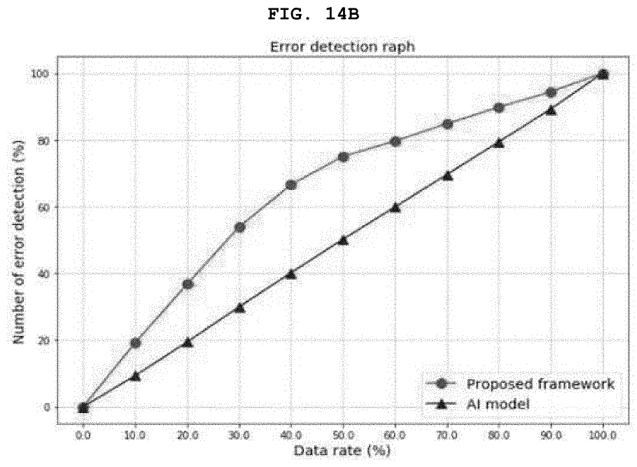

In the analysis and comparison of the error detection rates of the AI model and the AI model of FOS, the error detection rates of the AI model and the AI model for each data rate of the framework proposed in the present invention were compared, and it can be seen that the framework proposed in the present invention better detects errors than the AI model as illustrated in graphs of FIG. 14A and FIG. 14B. In addition, when data is 10% of the total, it can be seen that the AI error detection rate of the framework proposed in the present invention is 38.15% and is the highest detection rate.

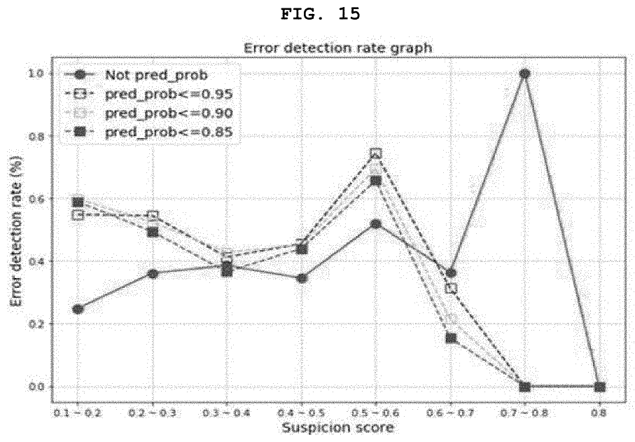

Looking at the result of FOS analysis including prediction probability, the AI error detection was performed including the prediction probability as well as FOS as an analysis method for AI error detection. In this case, the threshold of the prediction probability was set in three cases in total to analyze only data below the threshold. In general, when the prediction probability is below 0.95, it can be seen that the error detection rate of the AI model is high (see FIG. 15).

Looking at the FOS analysis result including the prediction probability, the AI error detection rate was the highest at threshold=0.5 of the suspicion score regardless of whether the prediction probability was included. In the case of suspicion score=0.5, the number of XAI determination suspicion was 75, the number of false positive of the XAI determination suspicion was 39, and thus the AI error detection rate was 52%. The number of XAI determination suspicion in which the prediction probability is 0.95 and the suspicion score is 0.4 was 43, the number of false positive of XAI determination suspicion was 32, and thus AI error detection rate was 74.42%.

Even in the method not including the prediction probability, erroneously detected data were found well, but it can be seen that, in the case of analysis including the prediction probability, errors of the AI were better found.

FIG. 16 is a diagram schematically illustrating a method according to the present invention.

The processing procedure steps in the method of the present invention are as follows.

1. An AI model based on training data for prediction of test data is generated. The AI model is generated after performing feature processing to effectively process a training process of the AI model.

2. XAI explainability is generated by using an AI model explainer and training data, and important features based on a summary plot are selected. An explainer of the AI model is generated through libraries in Python, a SHAP value is calculated by using training data in the explainer, and a summary plot is generated through the calculated SHAP value. In this case, in the summary plot, top 20 important features are calculated. 10 important features analyzable on the basis of analyst's knowledge are selected out of the 20 features.

3. Range processing based on data distribution of the selected important features is performed for unbiased analysis. A range group is generated by adding the SHAP value to the range group when the number of data corresponding to a unique value for each important feature is counted and satisfies a setting condition. The range is generated through the unique value of the features. For example, when the value of feature A in all data is [0.1, 0.1, 0.2, 0.3, 0.5], the range may be generated as [0.1-0.2, 0.2-0.3, 0.3-0.5].

4. A SHAP value average and standard deviation of each range group are calculated and then are stored to determine suspicion and reliability of test data. A range, average, and standard deviation for each feature are stored in FOS calculation information.

5. Prediction is made by using an AI model generated in advance after feature processing in the same way as the training data at the time of inputting the test data.

6. A SHAP value of the test data is calculated by using the test data and the explainer generated in advance.

7. FOS calculation information is loaded to calculate FOS for each important feature of the test data. A feature value of each data of the test data is compared to the range stored in the FOS calculation information, and then FOS(abs(CDF−0.5)*2) is calculated by using information of the corresponding group and a SHAP value of test data. A score representing a degree of abnormality for each important feature is calculated to determine reliability and suspicion of FOS (Feature Outlier Score) AI model prediction.

8. A suspicion score for each data is calculated by aggregating the FOS after calculating the FOS for each feature. There is FOS for each important feature of each data, and when the FOS is above a setting threshold, the feature determines that the prediction of the AI model is suspicious, and when the FOS is below the threshold, the feature determines that the prediction of the AI model is reliable. After the suspicion and reliability about the AI model prediction for each important feature are determined, a suspicion score is calculated by counting the number of suspicious features. As the calculated suspicion score gets higher, the data is screened as data requiring more additional review.

The present invention has the advantage of enabling efficient analysis by screening valuable alerts in a real security environment where a large number of cyber threats occur. As a result of testing on NSL KDD, an open IDS dataset to verify this, there is an effect of detecting errors in AI models with 92% improved performance compared to the existing system.

In the present invention, the above embodiments have been mainly described with reference to the accompanying drawings, but the present invention is not limited thereto. Claims set forth below are intended to cover many modifications that are evidently derived from these embodiments within the scope of the present invention.

What is claimed is:

1. A valuable alert screening method for detecting malicious threat, comprising:
generating an artificial intelligence (AI) model based on training data for prediction of test data;
generating explainable artificial intelligence (XAI) explainability and selecting important features based on summary plot by using an AI model explainer and the training data;
performing range processing based on data distribution of important features selected for analysis without bias;
calculating a SHAP value average and standard deviation of each range group and then storing them to determine suspicion and reliability of the test data;
making prediction by using an AI model generated in advance after feature processing in the same way as the training data at the time of inputting the test data;
calculating a SHAP value of the test data by using the test data and the AI model explainer generated in advance;
loading feature outlier score (FOS) calculation information to calculate FOS for each important feature of the test data; and
calculating a suspicion score for each data by aggregating the FOS after calculating the FOS for each feature.

2. The valuable alert screening method of claim 1, wherein in the generating of the XAI explainability and selecting the important features, an AI model explainer is generated through libraries in Python, a shapley additive explanations (SHAP) value is calculated by using the training data in the AI model explainer, a summary plot is generated through the calculated SHAP value, top 20 important features is generated in the summary plot, and 10 important features analyzable on the basis of analyst's knowledge are selected out of the 20 features.

3. The valuable alert screening method of claim 2, wherein in the performing of the range processing, a range group is generated by adding the SHAP value to the range group when the number of data corresponding to a unique value for each important feature is counted and satisfies a setting condition.

4. The valuable alert screening method of claim 3, wherein the range is generated through the unique value of the feature.

5. The valuable alert screening method of claim 2, wherein a range, average, and standard deviation for each important feature are stored in the FOS calculation information.

6. The valuable alert screening method of claim 2, wherein in the loading of the FOS calculation information, each import feature value of each data of the test data is compared to the range stored in the FOS calculation information, and then FOS=abs(CDF−0.5)*2 is calculated by using information of the corresponding group and a SHAP value of test data.

7. The valuable alert screening method of claim 6, wherein a score representing a degree of abnormality for each important feature is calculated to determine reliability and suspicion of FOS AI model prediction.

8. The valuable alert screening method of claim 2, wherein in the calculating of the suspicion score, there is FOS for each important feature of each data, and when the FOS is above a setting threshold, the feature determines that the prediction of the AI model is suspicious, and when the FOS is below the threshold, the feature determines that the prediction of the AI model is reliable.

9. The valuable alert screening method of claim 8, wherein after the suspicion and reliability about the AI model prediction for each important feature are determined, a suspicion score is calculated by counting the number of suspicious features.

10. The valuable alert screening method of claim 9, wherein as the calculated suspicion score gets higher, the data is screened as data requiring more additional review.
